(19) United States
(12) Patent Application Publication
(10) Pub. No.: US 2018/0091776 A1
(43) Pub. Date: Mar. 29, 2018

(54) PORTABLE VIDEO RECORDATION SYSTEM AND METHOD OF USING THE SAME

(71) Applicant: Kathryn Ann Trabert, Hawthorne, FL (US)

(72) Inventor: Kathryn Ann Trabert, Hawthorne, FL (US)

(21) Appl. No.: 15/276,931

(22) Filed: Sep. 27, 2016

(51) Int. Cl. H04N 7/18; A47B 37/00; H04N 5/247; H04N 5/225; H04N 5/77

(52) U.S. Cl. CPC H04N 7/181; A47B 37/00; H04N 5/77; H04N 5/2257; H04N 5/247

(57) ABSTRACT

A video recordation system is provided. The video recordation system embodies a portable recording device adapted to be for removably retrofitted along a periphery of game tables, such are card and billiard tables, for recording the game actions at a tabletop level, and transmitting the recorded game actions for broadcasting and promotional purposes.

### BACKGROUND OF THE INVENTION

The present invention relates to video systems for table games and, more particularly, to a portable video recordation system designed for removably retrofitting to game tables, such are card and billiard tables, for recording the game actions at a tabletop level.

At this time, there are no inexpensive, easily portable way to record the player's cards and their other tabletop-level playing actions in a card game, as currently the only options are prohibitively expensive and large, prefabricated table set ups. Likewise, there is no current system for recording the tabletop-level game action of a billiards game without investing in an expensive prefabricated billiards table with built-in video recordation devices or otherwise retrofitting a standard billiards (or card) table with a labor intensive and costly process of installing size-appropriate video devices.

As a corollary, billiards and card players without large sums of disposable monies, who are looking to learn from reviewing table-level video of their earlier play or practice, cannot afford to do so. Similarly, small-pocket tournament organizers are priced out of offering an engaging way of broadcasting and promoting their billiard and card events.

As can be seen, there is a need for a portable video recordation system embodying a device and method of using the same designed for removably retrofitting to game table, such are card and billiard tables, for recording the game actions at a tabletop level. For example, home-gamers could use the portable, low-cost device to record their poker and pool games, retro-fitting it between the two types of game tables, so as to for instance learn about their poker tells or how they approach certain pocket angles, respectively.

### SUMMARY OF THE INVENTION

In one aspect of the present invention, a video recording device for capturing tabletop level images from a game table includes a body of flexible material defining an elongated wedge shape, wherein the wedge shape is defined by a hypotenuse side interconnecting a first leg side and a second leg side; a plurality of video devices spaced apart and embedded in the wedge shape, wherein each video device is oriented facing the first leg side, wherein the first and second leg sides are perpendicular relative to each other, and including a plurality of video notches formed along the first leg so as that each of the plurality of video notches align with a respective video device of the plurality of video devices, wherein each of the plurality of video devices is spaced apart so as to be adapted to at least align with each of the pockets of a regulation billiards table, or wherein each of the plurality of video devices is spaced apart so as to be adapted to at least align with each of the seats of a regulation poker table, and including at least one electronic wiring, each electronic wiring having an electronic connector, wherein each electronic wire interconnects the plurality of video devices and its respective electronic connector, wherein a substantial portion of the at least one electronic wiring is embedded in the wedge shape, and wherein each electronic connector is not embedded in the wedge shape.

In another aspect of the present invention, a method of using the recording device for capturing tabletop level images of a game table having a bumper along a periphery of the game table, wherein the bumper interfaces with the tabletop at an incline, includes placing the device into a bumper void defined by the inclining bumper and the tabletop so that each seat of the regulation poker table is adjacent to at least one of the plurality of video devices, and wherein the first leg side is facing an opposing side of the tabletop, and providing a computing device and electronically connecting the plurality of video devices to the computing device, wherein the computing device is configured to produce representations of an output of the plurality of video devices.

In yet another aspect of the present invention, a system for capturing tabletop level images of a game table, includes a bumper along a periphery of the game table, wherein the bumper is disposed relative to the tabletop at an incline; a body of flexible material defining an elongated wedge shape, wherein the wedge shape is defined by a hypotenuse side interconnecting a first leg side and a second leg side; a plurality of video devices spaced apart and embedded in the wedge shape, wherein each video device is oriented facing the first leg side, wherein the second leg side and the hypotenuse side are adjacent to the tabletop and the inclined bumper, respectively; a plurality of video notches formed along the first leg so as that each of the plurality of video notches align with a respective video device of the plurality of video devices; at least one electronic wiring, each electronic wiring having an electronic connector, wherein each electronic wire interconnects the plurality of video devices and its respective electronic connector; and a computing device connected to each electronic connector.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention, shown in use;

FIG. 2 is a perspective view of an exemplary embodiment of the present invention;

FIG. 3 is a section view of an exemplary embodiment of the present invention, taken along line 3-3 of FIG. 1;

FIG. 4 is a perspective view of an exemplary embodiment of the present invention;

FIG. 5 is a perspective view of an exemplary embodiment of the present invention; and

FIG. 6 is a section view of an exemplary embodiment of the present invention, taken along line 6-6 of FIG. 5.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a video recordation system embodying a portable recording device adapted to be for removably retrofitted along a periphery of game tables, such are card and billiard tables, for recording the game actions at a tabletop level, and transmitting the recorded game actions for broadcasting and promotional purposes.

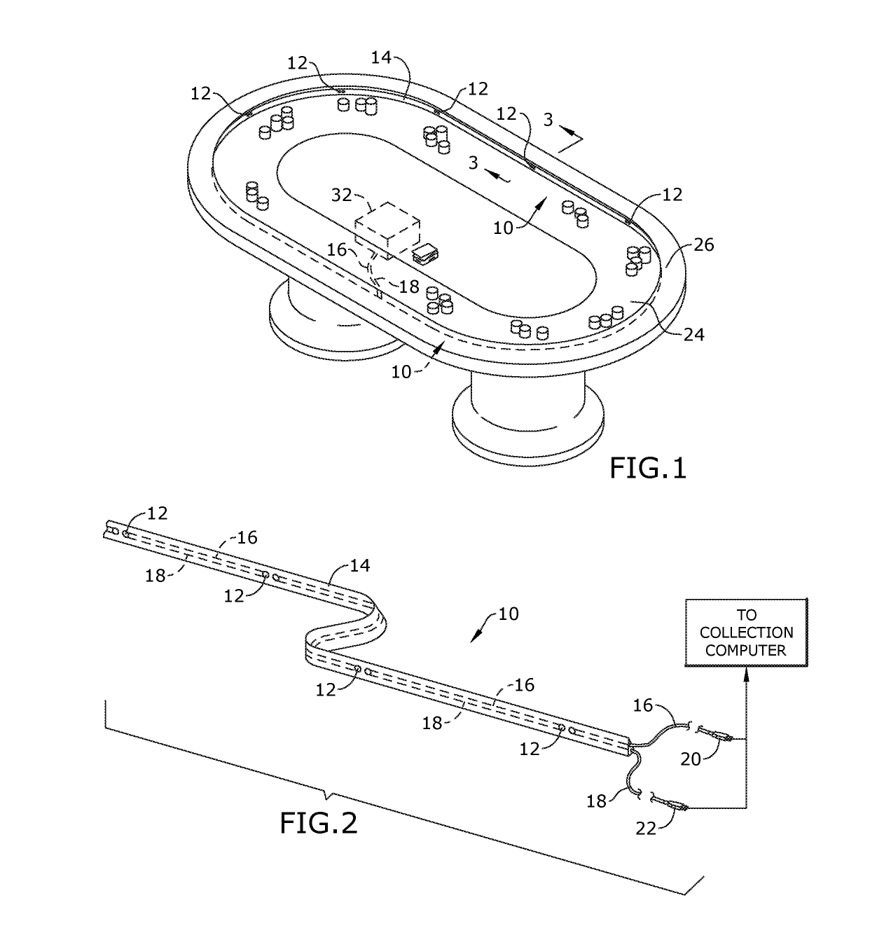

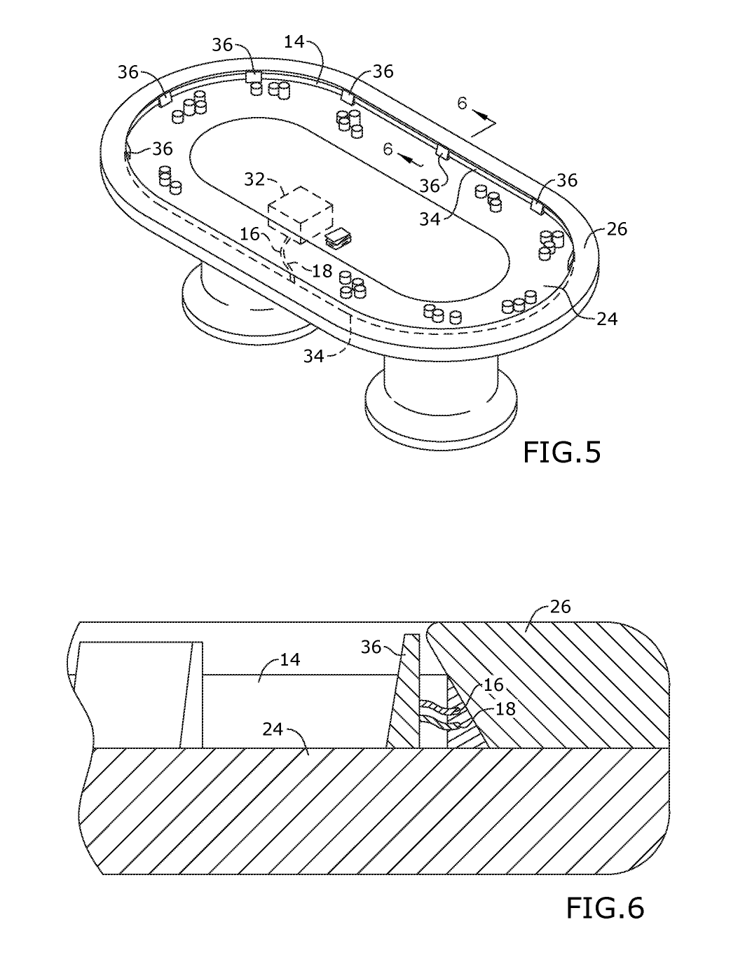

Referring to FIGS. 1 through 6, the present invention may include a portable video recordation system embodying a recording device 10 and a method of using the same. The recording device 10 may include a flexible, elongated body or strip 14 dimensioned and adapted to fill a portion of a bumper void defined by various game table bumper 26, 30, such as for poker tables 24 and billiard tables 28, respectively. The strip 14 may be made of any suitable flexible material so that the strip 14 may be repeatedly bent without fracturing, for example, when the strip 14 is selectively employed to wrap along the inner portions of different game table bumpers 26, 30.
The material may be polyethylene, polypropylene, vinyl, nylon, rubber, leather, various plasticized materials and the like.

The strip 14 may, in certain embodiments, may generally define a three-sided right triangle or wedge shape defined by a hypotenuse side interconnecting a first and second leg side. The hypotenuse and the second leg side may be placed into the bumper void so that the first leg side faces an opposing bumper, and wherein the bumper void is complementarily defined by the inclining table bumper and associated tabletop. The strip 14 is dimensioned and adapted so that when the wedge-side engages the bumper void, the table bumper 30 is still functional, in that, for example, a billiard ball will predictably ricochet there from in the case of a billiards table 28. In certain embodiments, the first or second leg sides are an inch or less.

The strip 14 may include electronic wiring 16, 18, for example, power and video cords, embedded in the elongated body/strip 14. The electronic wiring 16, 18 may provide electronic connectors 20, 22, such as power and video plugs, adapted to electronically connect to a computing device 32. In certain embodiments, the present invention may use wireless technology in lieu of electronic wiring 16, 18. In some embodiments, the electronic wiring 16, 18 may be outside of the body strip 14; for example, laid along the underside of the game table, and only interfacing the body strip 14 to connect to each of the plurality of video devices 12 embedded in and spaced apart along said body strip 14.

In certain embodiments, the video devices 12 may be pin hole cameras with wide-angle camera/lens, wherein the lens are the size of a pencil eraser. In other embodiments, a portion of the video devices is disposed outside the body strip 14 and electronically connected to their respective lens embodied in the body strip 14. The spacing of the plurality of video devices 12 may be determined based on in part the standard spacing for applicable table games. For example, a regulation billiards table needs its pockets spaced at predetermined locations along the tabletop, and so the plurality of video devices 12 may be spaced accordingly so there is at least one video device per pocket. With that said, the video devices may be positioned and orient to capture video and pictorial images at different angles and distances relative to the tabletop and, in this example, billiard pockets. Additionally, the spacing of the plurality of video devices 12 may incorporate and align with other spacing determinations, like the average distance players at a regulation poker table are spaced apart; for example, 10 seats per poker table 24 are typically used in a tournament poker game for all but the final table. In use, some of the plurality of video devices 12 may be selectively made operable and inoperable by the computing device 32 base on in part the need of their use.

In the wedge-shaped body strips 14, a video notch 40 may be provided along one of the leg sides facing the tabletop, each video notch 40 aligned with the spacing of an associated video device 12, so that the video devices 12 do not protrude from the body/strip 14, avoiding interference with the captured game playing. Furthermore, making the video notches 40 enable the video devices 12 accessible when in need of repair.

In some embodiments, the video devices 12 may be flat panel cameras 36, wherein the electronic wiring 16, 18 extends from the body strip 14, so that the flat panel cameras 36 may be more selectively positioned on the tabletop, as desired.

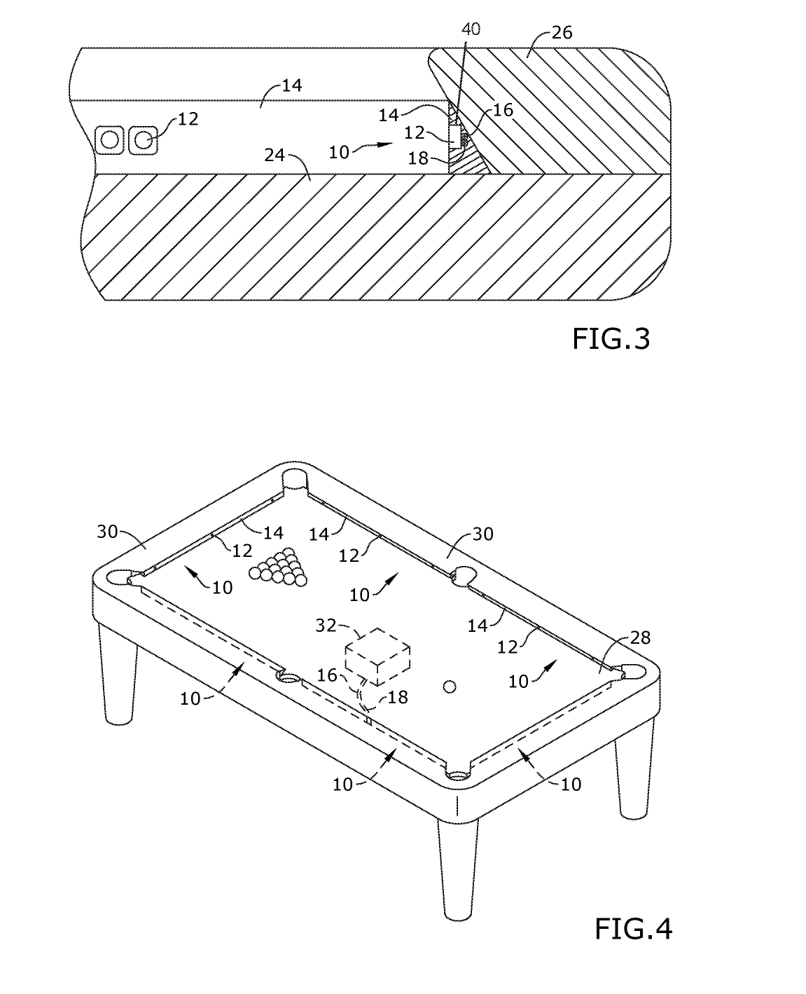

A method of using the present invention may be as follows. The recording device 10 disclosed above may be provided. A user may wedge the wedge-shaped strip 14 into the bumper void along the periphery of the tabletop, so that two of the three sides of the three-sided strip 14 are flush against the tabletop and the incline of the table bumper, as illustrated in FIG. 3. The user may position the strip 14 so that its plurality of video devices 12 aligned with predetermined points along the tabletop; for example, at or near billiard pockets, or at or near places where card players may be stationed at a card playing table so as to capture images of their cards. When the video devices 12 stop working, they can be easily replaced by accessing the video notch 40, or if it is too much trouble, the low cost of the present invention enables user to just replace the entire body strip 14/recording device 10.

Furthermore, in a certain method, the user may position the strip 14 in a place to capture an image of the playing cards of each card player. Such captured card images are sent to the computing device 32. The captured card images are tallied based on number of hands. These images can then be integrated with overhead images of the community cards in the associated card game, for example a poker game. When used in combination, a representation of what is happening, including captured cards images, can then be shown to an audience for further promoting or monetizing the card game. The audience could be a personal party, a tournament, an online platform, a television show, or the like. Each of the playing hands could be numbered and used in conjunction with each other for tournament play. The video devices 12 and the computing device 32 will be electronically connected so that software application loaded on the computing device 32 may be utilized during the above-mentioned process, including receiving the captured card images, queuing them for use, monitoring the playing hands and the like.

In addition, the present invention may be used for practice on pool/billiards tables, facilitating camera angles from each and every pocket, and could be enhanced to include non-pockets. Also, the present invention can produce a visual compilation of cards/billiards shots for future viewing or use. Additionally, the present invention could easily be used in other sporting events involving sedentary game playing, like role-play fantasy games.

It should be understood, of course, that the foregoing relates to exemplary embodiments of the invention and that modifications may be made without departing from the spirit and scope of the invention as set forth in the following claims.

What is claimed is:

1. A device, comprising:
a body of flexible material defining an elongated wedge shape, wherein the wedge shape is defined by a hypotenuse side interconnecting a first leg side and a second leg side; and
a plurality of video devices spaced apart and embedded in the wedge shape, wherein each video device is oriented facing the first leg side.

2. The device of claim 1, wherein the first and second leg sides are perpendicular relative to each other.

3. The device of claim 1, further comprising a plurality of video notches formed along the first leg so as that each of the plurality of video notches align with a respective video device of the plurality of video devices.

4. The device of claim 1, wherein each of the plurality of video devices is spaced apart so as to be adapted to at least align with each of the pockets of a regulation billiards table.

5. The device of claim 1, wherein each of the plurality of video devices is spaced apart so as to be adapted to at least align with each of the seats of a regulation poker table.

6. The device of claim 1, further comprising at least one electronic wiring, each electronic wiring having an electronic connector, wherein each electronic wire interconnects the plurality of video devices and its respective electronic connector.

7. The device of claim 6, wherein a substantial portion of the at least one electronic wiring is embedded in the wedge shape, and wherein each electronic connector is not embedded in the wedge shape.

8. A method of using the device of claim 5 for capturing tabletop level images of a game table having a bumper along a periphery of the game table, wherein the bumper interfaces with the tabletop at an incline, comprising:
placing the device into a bumper void defined by the inclining bumper and the tabletop so that each seat of the regulation poker table is adjacent to at least one of the plurality of video devices, and wherein the first leg side is facing an opposing side of the tabletop.

9. The method of claim 8, further comprising providing a computing device and electronically connecting the plurality of video devices to the computing device.

10. The method of claim 9, wherein the computing device is configured to produce representations of an output of the plurality of video devices.

11. A system for capturing tabletop level images of a game table, comprising:
a bumper along a periphery of the game table, wherein the bumper is disposed relative to the tabletop at an incline;
a body of flexible material defining an elongated wedge shape, wherein the wedge shape is defined by a hypotenuse side interconnecting a first leg side and a second leg side;
a plurality of video devices spaced apart and embedded in the wedge shape, wherein each video device is oriented facing the first leg side,
wherein the second leg side and the hypotenuse side are adjacent to the tabletop and the inclined bumper, respectively;
a plurality of video notches formed along the first leg so as that each of the plurality of video notches align with a respective video device of the plurality of video devices;
at least one electronic wiring, each electronic wiring having an electronic connector, wherein each electronic wire interconnects the plurality of video devices and its respective electronic connector; and
a computing device connected to each electronic connector.
